(19) United States
(12) Patent Application Publication
(10) Pub. No.: US 2014/0352662 A1
(43) Pub. Date: Dec. 4, 2014

(54) COMBUSTION STATE DETERMINATION DEVICE FOR INTERNAL COMBUSTION ENGINE

(71) Applicant: DAIHATSU MOTOR CO., LTD., Ikeda-shi, Osaka (JP)

(72) Inventors: Takeshi Serizawa, Ikeda-shi (JP); Hiroaki Oi, Ikeda-shi (JP)

(73) Assignee: DAIHATSU MOTOR CO., LTD., Ikeda-shi, Osaka (JP)

(21) Appl. No.: 14/359,236

(22) PCT Filed: Nov. 22, 2012
(86) PCT No.: PCT/JP2012/080263

§ 371 Date: May 19, 2014

(30) Foreign Application Priority Data
Nov. 28, 2011 (JP) 2011-258821

(51) Int. Cl. F02P 5/145

(52) U.S. Cl. CPC F02P 5/145
USPC 123/406.27

(57) ABSTRACT

A spark ignition type internal combustion engine 1 causes a spark discharge generated between a center electrode 22 and a ground electrode 23 and an electric field generated via an antenna 16 facing inside of a combustion chamber 6 to interact to generate a plasma and ignite a fuel-air mixture. A combustion state determination device used in the spark ignition type internal combustion engine 1 determines a combustion state of the internal combustion engine 1 by comparing a strength of a reflected wave of an electromagnetic wave applied into the combustion chamber 6 from the antenna 16 with a threshold of a combustion state derived in advance by an experiment. This allows for the determination of the combustion state of the spark ignition type internal combustion engine that causes the spark discharge and the electric field to interact to generate the plasma and ignite the fuel-air mixture.

### TECHNICAL FIELD

The present invention relates to a determination device that determines a combustion state in a cylinder of an internal combustion engine.

### BACKGROUND ART

There is an approach of detecting an ion current flowing in electrode of a spark plug at combustion, as an example of the approach for estimating a combustion state of the fuel in the cylinder (see, for example, patent document 1). When there is an inferior combustion such as an over-lean, the combustion becomes excessively slow compared to the normal combustion, and the peak of the ion current decreases and the duration of the ion current flow becomes longer. As mentioned above, the change in the ion current is measured to determine whether or not its maximum value exceeds a determination threshold, or whether the duration in which the ion current exceeds a determination threshold (this threshold is different from the previously described threshold) is shorter or longer. This allows for the determination as to whether or not the combustion is normal. If the ion current cannot be detected, it of course means that a misfire occurs in the cylinder.

By the way, in the ignition device implemented in the spark ignition type internal combustion engine, a high voltage generated at the ignition coil is applied to a center electrode of the spark plug upon the arc extinction of the igniter. This triggers the spark discharge between the center electrode and the ground electrode of the spark plug and an ignition occurs. Further, the “active ignition” approach has been tried in recent years in order to ensure the ignition to the fuel-air mixture in the combustion chamber of the cylinder and obtain stable frame (see, for example, patent document 2). In the “active ignition” approach, a microwave outputted from an electric field generation circuit, in other words, a magnetron or a high frequency wave outputted from the high frequency oscillator is radiated into the combustion chamber. According to the active ignition approach, the microwave or the high frequency wave is formed in the gap between the center electrode and the ground electrode. The plasma generated in this electric field grows, which allows for the generation of a large frame core that is the start of the frame propagation combustion.

In the spark ignition type internal combustion engine employing the above-described active ignition, however, there is a problem that it is difficult to make an accurate determination of the misfire by using the ion current. This is due to the fact that, in the spark ignition type internal combustion engine with the use of the electromagnetic wave such as the microwave or the high frequency wave, the ion current cannot be detected during the application of the electromagnetic wave. Therefore, in the spark ignition type internal combustion engine with the use of the electromagnetic wave such as the microwave or the high frequency wave, there is a limit in the duration for the application of the electromagnetic wave and thus there remains a problem for implementation.

Further, in the above internal combustion engine, in the case that the misfire cannot be detected, the energy of the electromagnetic wave is reflected without changing into other form and returns to the electromagnetic wave oscillator such as the oscillator of the microwave or the high frequency wave. In details, the electromagnetic wave energy generated by the electromagnetic wave oscillator is transmitted by a waveguide and the like into the combustion chamber that is the irradiation unit. When there is no combustion product material that is to be heated within the combustion chamber or there is a light load combustion product material, the electromagnetic wave energy is not sufficiently absorbed by the combustion product material and most part thereof is reflected back to the electromagnetic wave oscillator. As the reflected energy increases, it is likely to cause the cathode (the negative electrode) of the microwave oscillator to be heated and its temperature to become high resulting in a breakdown, and/or cause more discharge of the electrons resulting in an unstable oscillation.

As mentioned above, the electromagnetic wave oscillator is subjected to the heavy load at the misfire state. Further, even when there is no misfire, the electromagnetic wave oscillator is subjected to a heavy load similarly to the case of the misfire state before the combustion product material reaches the high energy part of the electromagnetic wave. This is likely to cause the failure of the electromagnetic wave oscillator.

### CITATION LIST

### Patent Literatures

Patent document 1: JP-A-H6-34490

Patent document 2: JP-A-2011-144773

### SUMMARY OF INVENTION

### Problem to be Solved by the Invention

The object of the present invention is to determine the combustion state in the spark ignition type internal combustion engine that causes the spark discharge and the electric field to interact to generate the plasma and ignite the fuel-air mixture.

### Solution to the Problems

One form of the present invention employs the following configuration in order to solve the above-described problem. That is, a combustion state determination device for an internal combustion engine according to the present invention is featured in that, in a spark ignition type internal combustion engine that causes a spark discharge generated between a center electrode and a ground electrode and an electric field generated via an antenna facing inside of a combustion chamber to interact to generate a plasma and ignite a fuel-air mixture, it determines a combustion state of the internal combustion engine by comparing a strength of a reflected wave of an electromagnetic wave applied into the combustion chamber from the antenna with a threshold of a combustion state derived in advance by an experiment.

The above-described configuration allows for knowing the combustion state even in the period in which the electromagnetic wave is applied to the combustion chamber. Therefore, the adverse reflection of the electromagnetic wave that is reflected back to the electromagnetic wave generation device in the case of a misfire can be estimated. Thus, the electromagnetic wave generation device can be protected in advance. As a result, the obstacle to the implementation can be removed. Further, conventionally, a long duration could not be set for the application of the electromagnetic wave. According to one form of the present invention, however, the combustion state determination of the internal combustion engine is not done by the ion current. Thus, there is no period in which the electromagnetic wave cannot be applied after the spark ignition. Therefore, a longer duration can be set for the application of the electromagnetic wave, compared to the conventional art. This facilitates the combustion, so that the fuel consumption can be improved compared to the conventional art.

One preferable form may be that, when the strength of the reflected wave is greater by a certain amount than the threshold, it is determined that the internal combustion engine is in a misfire state.

It is preferable that the threshold includes a combustion failure threshold that is a determination criteria of a misfire state and a good combustion threshold that is a determination criteria of a good combustion state, and an electromagnetic wave control device is provided that reduces an application energy of the electromagnetic wave to cause the strength of the reflected wave to be closer to the good combustion threshold when the strength of the reflected wave is less than the combustion failure threshold and greater than the good combustion threshold. That is, under the state where the combustion is not good while it does not reach the misfire, the combustion is improved by the control of increasing the fuel injection amount, reducing the ERG amount, and the like so as to cause the strength of the reflected wave to be closer to the good combustion threshold. As a result, this allows for the protection of the electromagnetic wave generation device.

### Advantageous Effects of the Invention

The present invention is configured as described above. This allows for the determination of the combustion state of the spark ignition type internal combustion engine that causes the spark discharge and the electric field to interact to generate the plasma and ignite the fuel-air mixture. The objects, features, aspects, and advantages will become clearer by the following detailed description and the attached drawing.

### BRIEF DESCRIPTION OF THE DRAWINGS

FIG. 1 illustrates a configuration of an internal combustion engine of one embodiment of the present invention.

### DESCRIPTION OF EMBODIMENTS

One embodiment of the present invention will be described below by referring to the drawing.

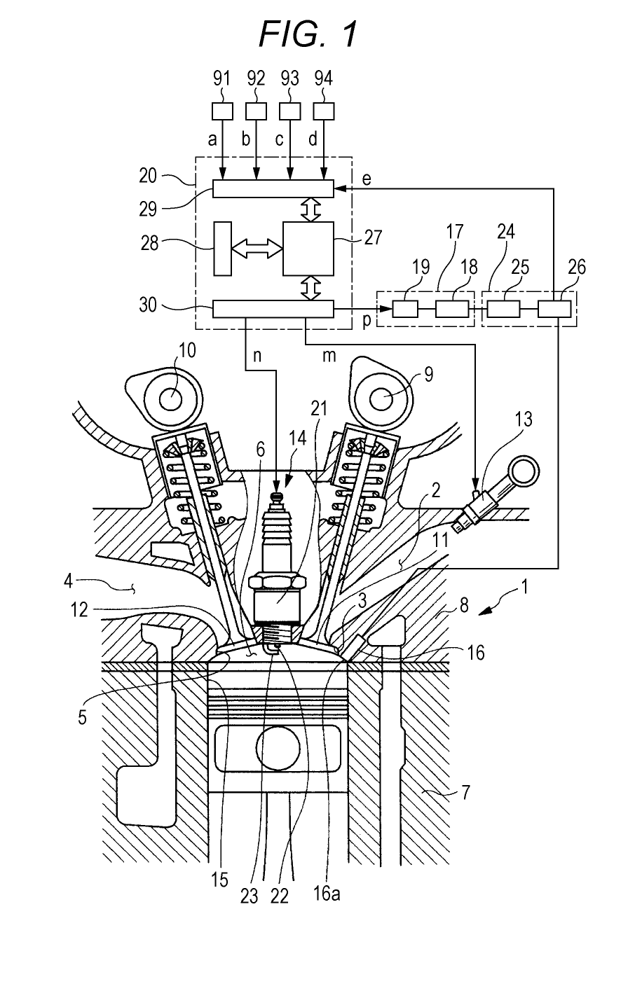

A spark ignition type internal combustion engine 1 whose attachment parts of an intake valve 11 and an exhaust valve 12 are illustrated in FIG. 1 is of the type of double overhead cam shaft (DOHC). An opening 3 of an intake port 2 and an opening 5 of an exhaust port 4 are arranged opposed to each other interposing a spark plug 14 as the center that is attached substantially the center of the ceiling part of a combustion chamber 6. The opening 3 of the intake port 2 and the opening 5 of the exhaust port 4 are opened at two parts per one cylinder, respectively. That is, the internal combustion engine 1 has a cylinder block 7, and a cylinder head 8 that is attached to the upper part of the cylinder block 7 and forms the ceiling part of the combustion chamber 6. Further, cam shafts 9 and 10 are respectively attached to the intake side and the exhaust side of the cylinder head 8. The intake port 2 of the cylinder head 8 is opened and shut by the intake valve 11 that moves in a reciprocating manner by the rotation of the cum shaft 9. Also, the exhaust port 4 is opened and shut by the exhaust valve 12 that moves in a reciprocating manner by the rotation of the cum shaft 10. Further, a fuel injection valve 13 is attached to the intake port 2. The spark plug 14 is attached to the ceiling part of the combustion chamber 6.

The spark plug 14 has a housing 21 made of a conductive material, a center electrode 22 attached inside the housing 21 in an insulating manner, and a ground electrode 23. The ground electrode 23 is separated away from the center electrode 22 and provided to the lower end of the housing 21. An igniter is connected to the spark plug 14.

In the present embodiment, an antenna 16 for generating a plasma is provided to the part of the intake valve 11 side of an internal wall 15 of the cylinder, more specifically, the internal wall of the combustion chamber 6. The antenna 16 is the monopole type antenna and is attached to the position near the spark plug 14 of the ceiling of the combustion chamber 6. In the antenna 16, an end 16a is exposed facing the inside of the cylinder. The rest part of the antenna 16 is coated with a not-shown insulating member. In detail, the surface of the end 16a of the antenna forms the same surface as the internal surface of the combustion chamber 6. The antenna 16 is connected with a microwave generation device 17 that outputs a microwave that is an electromagnetic wave.

The microwave generation device 17 that is the electromagnetic wave generation device has a magnetron 18 that is a microwave generation source and a control circuit 19 that controls the magnetron 18. The microwave outputted by the magnetron 18 is applied to the antenna 16 via a microwave transmission circuit 24 including a waveguide. A microwave generation signal p outputted from an electronic control device 20 described later is inputted in the control circuit 19. Based on the microwave generation signal p, the control circuit 19 controls the output timing and the output power of the microwave outputted by the magnetron 18.

The microwave transmission circuit 24 has the waveguide, an isolator 25, and a power meter 26.

The isolator 25 is the protection equipment for allowing a stable operation of the microwave generation device 17 by absorbing the reflected wave from the antenna 16. The isolator 25 is mounted between the magnetron 18 and the antenna 16 that is the irradiation unit. The isolator 25 includes a circulator and a dummy load. The circulator separates the incoming radiation power, which is provided by the oscillation of the microwave generation device 17, from the reflected power, which is reflected from the antenna 16, by the effect of the ferrite provided at the T-shaped part of the waveguide and the magnetic field. The circulator then transmits the incoming radiation power to the antenna 16 with substantially no loss. Furthermore, the circulator separates the reflected power and introduces it to the dummy load side. It is noted that the reflected power is absorbed by the water and the like of the water-cooled dummy load and exhausted as a heat. The dummy load is connected to the end of the waveguide and efficiently absorbs the excessive microwave energy.

A power meter 26 separates the microwave energy (the incoming radiation power) transmitted from the microwave generation device 17 to the antenna 16 from the power (the reflected power) reflected from the antenna 16, and detects and displays them. The power meter 26 is inserted in a part of the waveguide. In details, the power meter 26 is configured with a directional coupler, a coaxial non-reflective terminator, a crystal mount that is a diode for microwave, an ammeter, a coaxial cable, and so on. It is noted that, when there is one set of an indicator and a detection unit, the power meter 26 is capable of reading the incoming radiation power and the reflected power, respectively, by the alternate connection of the crystal mount and the coaxial non-reflective terminator. In the present embodiment, the detection units of the directional coupler are provided to both sides of the waveguide, to each of which the crystal mount, the coaxial non-reflective terminator, and the indicator are connected. This allows the incoming radiation power and the reflected power to be read at the same time.

The electronic control device 20 is configured with a microcomputer system as the primary member that has a central processing unit 27, a storage unit 28, an input interface 29, and an output interface 30.

The central processing unit 27 performs the drive control of the internal combustion engine 1 by executing the program described later stored in the storage unit 28. Then, the information necessary for the drive control of the internal combustion engine 1 is inputted in the central processing unit 27 via the input interface 29. The central processing unit 27 outputs the signals for the control to the fuel injection valve 13, the spark plug 14, the control circuit 19, and so on via the output interface 30.

Specifically, an air flow rate signal a, a revolution speed signal b, a water temperature signal c, a voltage signal d, a reflected wave signal e, and so on are inputted in the input interface 29. The air flow rate signal a is outputted from an air flow meter 91 that detects the air flow rate flowing into the intake port 2. The revolution speed signal b is outputted from a revolution speed sensor 92 that detects the number of revolution of the engine. The water temperature signal c is outputted from a water temperature sensor 93 that detects the cooling water temperature of the internal combustion engine 1. The voltage signal d is outputted from an O₂ sensor 94. The reflected wave signal e is outputted from the power meter 26. On the other hand, the output interface 30 outputs a fuel injection signal m to the fuel injection valve 13, outputs an ignition signal n to the spark plug 14, and outputs a microwave generation instruction signal p and the like to the control circuit 19 of the magnetron 18.

That is, the control device 20 obtains the various pieces of information a, b, c, d, and e via the input interface 29 that are necessary for the drive control of the internal combustion engine 1. Based on them, the control device 20 calculates the intake amount, the required fuel injection amount, the ignition timing, and so on. The control device 20 then applies various pieces of information m, n, and p corresponding to the calculation result via the output interface 30.

Here, the control device 20 incorporates a combustion state determination program. The combustion state determination program is a program for comparing the strength of the reflected wave of the microwave applied into the combustion chamber 6 from the antenna 16 with a threshold of the combustion state that has been derived in advance by experiments and determining the combustion state of the internal combustion engine 1. More specifically, this combustion state determination program sequentially performs a process for obtaining the strength of the reflected wave indicated by the reflected wave signal e, a process for determining a voltage to be applied to the antenna 16 by referring to a map where the strength of the reflected wave is set as a parameter, and a process of outputting the corresponding microwave generation signal p to the control circuit 19 in order to apply the application voltage determined by the above-described process to the antenna 16. Here, the map is stored in a predetermined area of the storage unit 28 and indicates the application voltages to the antenna 16 with respect to the parameter of the typical reflected wave strengths, which have been determined in advance by experiments.

In the present embodiment, another program is further embedded in the storage unit 28 of the electronic control device 20. This program is a program for performing the control that causes the electric field generated inside the combustion chamber 6 and the spark discharge by the spark plug 14 to react to generate a plasma and ignite the fuel-air mixture while the fuel is supplied during traveling of the vehicle and, on the other hand, stops the generation of the plasma if the internal combustion engine 1 is determined to be in a misfire during traveling of the vehicle.

In the internal combustion engine 1, the microwave generated by the microwave generation device 17 is radiated into the combustion chamber 6 from the antenna 16 simultaneously with the output timing that is controlled by the control circuit 19. The electric field generated as described above and the spark discharge by the spark plug 8 are caused to interact, so that the plasma is generated and the fuel-air mixture is ignited. When the plasma is generated, the microwave is applied to the antenna 16, so that the electric field is formed in the direction orthogonal to the spark discharge by the spark plug 14 inside the combustion chamber 6. Therefore, the antenna 16 and the microwave generation device 17 configure electric field generation means.

As discussed above, in the ignition, the spark discharge is generated at the spark plug 14 by the ignition coil. The electric field is generated by the microwave at substantially the same time as the start of the spark discharge, immediately after the start of the spark discharge, or immediately before the start of the spark discharge, and the spark discharge and the electric field are caused to interact, so that the plasma is generated. This allows for the rapid combustion of the fuel-air mixture inside the combustion chamber 6. It is noted that the time immediately after the start of the spark discharge preferably corresponds to at latest the start time of the trigger discharge forming the spark discharge.

Specifically, the spark discharge by the spark plug 14 becomes the plasma in the electric field and, in this plasma, the fuel-air mixture is ignited, so that a larger frame core that is the start of the frame propagation combustion is obtained compared to the ignition by the spark discharge only. Furthermore, a large number of radials are generated inside the combustion chamber 6. This facilitates the combustion.

This is due to the following reason. That is, the flow of the electrons by the spark discharge and the ions and radials generated by the spark discharge vibrate or meander affected by the electric field. This results in longer traveling lengths thereof, which significantly increases the number of collisions to ambient water molecules and nitrogen molecules. The water molecules and the nitrogen molecules subjected to the collision to the ions or the radicals become OH radicals and N radicals. Furthermore, the ambient gas subjected to the collision to the ions and radicals is caused to be in the ionized state, that is, the plasma state. This results in a significantly larger ignition area to the fuel-air mixture and also a larger frame core. As a result, the ignition is amplified to the three-dimensional-like ignition from the two-dimensional-like ignition by the spark discharge only. Thus, the combustion rapidly propagates inside the combustion chamber 6 and expands at a high combustion speed.

Described below will be the general procedure of the determination and control of the combustion state in the combustion state determination device for the internal combustion engine 1.

First, a strength of a reflected wave of a microwave applied into the combustion chamber 6 from the antenna 16 is detected by the power meter 26. That is, the reflected wave is taken by the same antenna 16 as that radiates the microwave. The strength of the reflected wave that has passed the antenna 16 is detected before the microwave generation device 17.

Next, at the electronic control device 20 that is the combustion state determination device, the map is referred and the detected strength of the reflected wave is compared to a threshold of the combustion state in the map to make a determination described later. Here, the reason for comparing the strength of the reflected wave with the threshold is as follows. The microwave oscillating via the antenna 16 facing the inside of the combustion chamber 6 like in the present embodiment has the characteristics that the reflected wave from the antenna 16 decreases in the combustion state where there is a combustion product material, while the reflected wave from the antenna 16 increases in the misfire state where there is no combustion product material. Therefore, when the strength of the reflected wave is greater by a certain amount than the combustion failure threshold that is the determination criteria of the misfire state, it is determined that the internal combustion engine 1 is in the misfire state. When the strength of the reflected wave is less than the combustion failure threshold and is greater than the good combustion threshold that is the determination criteria of the good combustion state, it is determined that the internal combustion engine 1 is in the combustion state but not in the good combustion state. Further, the strength of the reflected wave is less than the threshold, it is determined that the internal combustion engine 1 is in the good combustion state.

When it is determined that the internal combustion engine 1 is in the misfire state, the electronic control device 20 that is the electromagnetic wave control device performs the control to stop the application of the microwave to the antenna 16 and stop the generation of the plasma. Specifically, such control is implemented that the microwave generation signal p is outputted from the output interface 29 and no oscillation of the microwave occurs from the magnetron 18.

When it is determined that the internal combustion engine 1 is in the combustion state but not in the good combustion state, the electronic control device 20 that is the electromagnetic wave control device performs the control to reduce the application energy of the microwave and cause the strength of the reflected wave to be closer to the good combustion threshold. Further, in order to improve the combustion state, the amount of the fuel injection is increased, for example.

When it is determined that the internal combustion engine 1 is in the good combustion state, the electronic control device 20 that is the electromagnetic wave control device performs the control to increase the application energy of the microwave. In the present embodiment, in order to eliminate the redundant application when the internal combustion engine 1 is in the misfire state, such control is implemented that the input energy is initially set smaller and, when it is detected that the reflected wave is less than the good combustion threshold and the good combustion state is obtained, the application energy is increased. In other words, the initial application energy of the microwave for each combustion is the value less than the amount of the peak energy at the threshold of the good combustion state. After it is detected that the internal combustion engine 1 is not in the misfire, the application energy is increased during the same expansion stroke.

As described above, the magnetron 18 and the control circuit 19 of the microwave generation device 17, the power meter 26 of the microwave transmission circuit 24, and the electronic control device 20 cooperate and function as the combustion state determination device of the present invention.

As discussed above, in the spark ignition type internal combustion engine 1 that causes the spark discharge generated between the center electrode 22 and the ground electrode 23 and the electric field generated via the antenna 16 facing the inside of the combustion chamber 6 to interact to generate the plasma and ignite the fuel-air mixture, the combustion state determination device of the spark ignition type internal combustion engine 1 of the present embodiment determines the combustion state of the internal combustion engine 1 by comparing the strength of the reflected wave of the microwave applied into the combustion chamber 6 from the antenna 16 with the threshold of the combustion state derived in advance by the experiment. As set forth, output of the microwave that has the characteristics that the presence of the combustion product material inside the combustion chamber 6 results in the reduced reflection is monitored. The detection of the strength of such reflected wave allows for the determination as to whether the internal combustion engine 1 is in the combustion state or the non-combustion (misfire) state. That is, the misfire can be detected even in the period in which the microwave is applied to the combustion chamber 6. It was not possible in the conventional art.

Further, when the strength of the reflected wave is greater by a certain amount than the combustion failure threshold, it is determined that the internal combustion engine is in the misfire state, so that the adverse reflection of the electromagnetic wave reflected back to the electromagnetic wave generation device can be estimated in the case of the misfire. Thus, a proper control of the application energy allows for a smaller load to the microwave generation device 17. Further, conventionally, a long duration could not be set for the application of the electromagnetic wave. In the present embodiment, however, the combustion state determination of the internal combustion engine is not done by the ion current. Thus, there is no period in which the electromagnetic wave cannot be applied after the spark ignition. This allows a longer duration to be set for the application of the electromagnetic wave, compared to the conventional art. This allows for the advantage that the combustion is facilitated and thus the fuel consumption can be improved compared to the conventional art.

Further, the electromagnetic wave control device is provided that applies the control to reduce the application energy of the electromagnetic wave to cause the strength of the reflected wave to be closer to the good combustion threshold when the strength of the reflected wave is less than the combustion failure threshold that is the determination criteria of the misfire state and greater than the good combustion threshold that is the determination criteria of the good combustion state. Therefore, in addition to the above-described advantages, the combustion can be improved under the state where the misfire is not reached but the combustion is not good.

In particular, the antenna 16 of the present embodiment is used in applying the microwave to the combustion chamber 6 and in reflecting the microwave reflected from the combustion chamber 6 to the combustion state determination device. This allows for the compact arrangement of the internal combustion engine 1.

It is noted that the present invention is not limited to the above-described embodiment.

The electromagnetic wave generation device for generating the electric field inside the combustion chamber in order to generate the plasma inside the combustion chamber is not limited to the microwave generation device. Besides the microwave generation device, the electromagnetic wave generation device may be an AC voltage generation circuit for applying a high frequency AC voltage, a undulating voltage generation circuit for applying a high frequency undulating voltage, and so on. When the undulating voltage generation circuit is employed, it may be any circuit that generates a DC voltage whose voltage changes periodically, and any waveform can be employed. The undulating voltage generally includes a pulse voltage that changes from the reference voltage (it may be 0 V) to a certain voltage in a certain period, a half-wave rectified AC voltage, a DC-biased AC voltage, and the like. The frequency of the high frequency voltage at which the electric field generation device oscillates is preferably around 200 kHz to 1000 kHz. Furthermore, the amplitude of the high frequency voltage is preferably around 3 kVp-p to 10 kVp-p.

With respect to the microwave, the dedicated antenna is provided as described above. However, the microwave may be radiated to the combustion chamber by using a spark plug. Further, it is possible that the spark plug is used as the receiving antenna for the reflected wave of the microwave radiated from the separated antenna. In addition, the antenna may be, for example, a horn type antenna besides the monopole type antenna.

In addition to the above, the specific configuration of each part is not limited to the above-described embodiment, but it can be modified in various ways without departing from the spirit of the present invention.

The present application is based on Japanese Patent Application No. 2011-258821 filed on Nov. 28, 2011 in Japan by the same applicant, the entire disclosure of which is incorporated in the present application by reference.

The above descriptions regarding the particular embodiment of the present invention have been presented for the purpose of illustration. They are not intended to be exhaustive or to limit the present invention to the described forms as they stand. It is evident for those skilled in the art that a number of modifications or variations are possible in view of the above-described disclosures.

### INDUSTRIAL APPLICABILITY

The present invention is applicable to the spark ignition type internal combustion engine mounted on the vehicle and the like.

### DESCRIPTION OF REFERENCE SIGNS

1 Internal combustion engine
6 Combustion chamber
16 Antenna
22 Center electrode
23 Ground electrode

1. A combustion state determination device for an internal combustion engine used in a spark ignition type internal combustion engine that causes a spark discharge generated between a center electrode and a ground electrode and an electric field generated via an antenna facing inside of a combustion chamber to interact to generate a plasma and ignite a fuel-air mixture,
wherein the combustion state determination device determines a combustion state of the internal combustion engine by comparing a strength of a reflected wave of an electromagnetic wave applied into the combustion chamber from the antenna with a threshold of a combustion state derived in advance by an experiment.

2. The combustion state determination device for the internal combustion engine according to claim 1, wherein, when the strength of the reflected wave is greater by a certain amount than the threshold, it is determined that the internal combustion engine is in a misfire state.

3. The combustion state determination device for the internal combustion engine according to claim 1, wherein the threshold includes a combustion failure threshold that is a determination criteria of a misfire state and a good combustion threshold that is a determination criteria of a good combustion state, and
wherein the combustion state determination device for the internal combustion engine includes an electromagnetic wave control device adapted to reduce an application energy of the electromagnetic wave to cause the strength of the reflected wave to be closer to the good combustion threshold when the strength of the reflected wave is less than the combustion failure threshold and greater than the good combustion threshold.
